(19) United States
(12) Patent Application Publication
(10) Pub. No.: US 2026/0169181 A1
(43) Pub. Date: Jun. 18, 2026

(54) FULL WAVEFORM INVERSION SEISMIC IMAGING

(71) Applicant: SCHLUMBERGER TECHNOLOGY CORPORATION, Sugar Land, TX (US)

(72) Inventors: Xin CHENG, Houston, TX (US); Denes VIGH, Houston, TX (US); Bing BAI, Houston, TX (US); Mohamed HEGAZY, Houston, TX (US)

(21) Appl. No.: 19/119,784

(22) PCT Filed: Oct. 17, 2022
(86) PCT No.: PCT/US2022/046823

§ 371 Date: Apr. 10, 2025

(51) Int. Cl. G01V 1/28; G01V 1/30; G01V 1/32

(52) U.S. Cl. CPC G01V 1/282; G01V 1/303; G01V 1/325; G01V 2210/614; G01V 2210/6222; G01V 2210/675; G01V 2210/679

(57) ABSTRACT

A method can include generating synthetic seismic data using a velocity model of a subsurface geologic environment; perturbing the velocity model of the subsurface geologic environment to generate a perturbed velocity model of the subsurface geologic environment; performing an iteration of a full-waveform inversion using the synthetic seismic data and the perturbed velocity model to generate seismic survey source and receiver illumination weights; and generating an image of the subsurface geologic environment using the seismic survey source and receiver illumination weights, where the seismic source and receiver illumination weights act to balance seismic illumination.

### BACKGROUND

Reflection seismology finds use in geophysics to estimate properties of subsurface formations. Reflection seismology may provide seismic data representing waves of elastic energy as transmitted by P-waves and S-waves, in a frequency range of approximately 1 hertz (Hz) to approximately 100 Hz. In various instances, seismic data can also represent refractions and/or diving waves. Seismic data may be processed and interpreted to understand better composition, fluid content, extent and geometry of subsurface rocks. For example, a full-waveform inversion (FWI) may be implemented as part of a seismic data workflow for building a model of a subsurface environment where information from reflections, refractions and/or diving waves may be considered.

### SUMMARY

A method can include generating synthetic seismic data using a velocity model of a subsurface geologic environment; perturbing the velocity model of the subsurface geologic environment to generate a perturbed velocity model of the subsurface geologic environment; performing an iteration of a full-waveform inversion using the synthetic seismic data and the perturbed velocity model to generate seismic survey source and receiver illumination weights; and generating an image of the subsurface geologic environment using the seismic survey source and receiver illumination weights, where the seismic source and receiver illumination weights act to balance seismic illumination. A system can include a processor; memory operatively coupled to the processor; and processor-executable instructions stored in the memory to instruct the system to: generate synthetic seismic data using a velocity model of a subsurface geologic environment; perturb the velocity model of the subsurface geologic environment to generate a perturbed velocity model of the subsurface geologic environment; perform an iteration of a full-waveform inversion using the synthetic seismic data and the perturbed velocity model to generate seismic survey source and receiver illumination weights; and generate an image of the subsurface geologic environment using the seismic survey source and receiver illumination weights, where the seismic source and receiver illumination weights act to balance seismic illumination. One or more computer-readable storage media can include computer-executable instructions executable to instruct a computing system to: generate synthetic seismic data using a velocity model of a subsurface geologic environment; perturb the velocity model of the subsurface geologic environment to generate a perturbed velocity model of the subsurface geologic environment; perform an iteration of a full-waveform inversion using the synthetic seismic data and the perturbed velocity model to generate seismic survey source and receiver illumination weights; and generate an image of the subsurface geologic environment using the seismic survey source and receiver illumination weights, where the seismic source and receiver illumination weights act to balance seismic illumination. Various other examples of methods, systems, devices, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment;

FIG. 2 illustrates examples of survey techniques;

FIG. 3 illustrates examples of survey techniques;

FIG. 4 illustrates examples of survey techniques;

FIG. 5 illustrates an example of forward modeling and an example of inversion;

FIG. 6 illustrates an example of a full-waveform inversion method;

FIG. 7 illustrates an example of a method and an example of a computing system;

FIG. 8 illustrates example images of a survey design process;

FIG. 9 illustrates an example of a method and an example of a computing system;

FIG. 10 illustrates an example of a computational framework; and

FIG. 11 illustrates components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics to estimate properties of subsurface formations. Reflection seismology can provide seismic data representing waves of elastic energy, as transmitted by P-waves and S-waves, in a frequency range of approximately 1 Hz to approximately 100 Hz or optionally less than 1 Hz and/or optionally more than 100 Hz. Seismic data may be processed and interpreted to understand better composition, fluid content, extent and geometry of subsurface rocks.

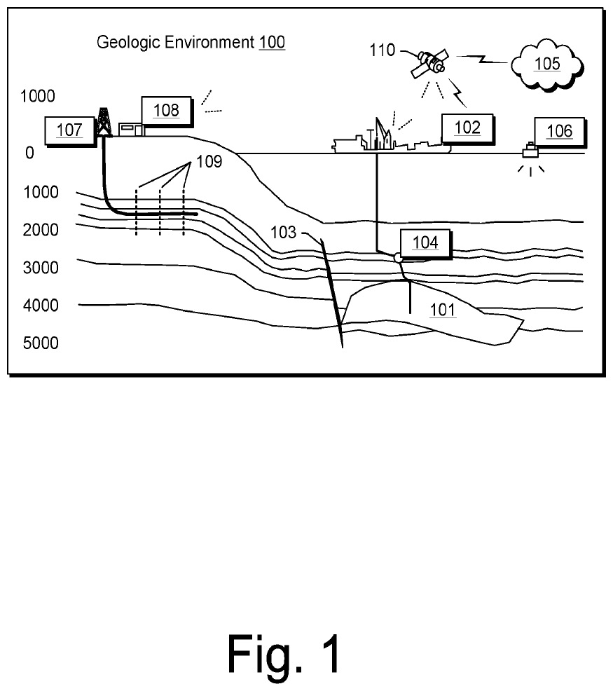

FIG. 1 shows a geologic environment 100 (an environment that includes a sedimentary basin, a reservoir 101, a fault 103, one or more fractures 109, etc.) and an example of an acquisition technique 140 to acquire seismic data (see data 160). A system may process data acquired by the technique 140 to allow for direct or indirect management of sensing, drilling, injecting, extracting, etc., with respect to the geologic environment 100. In turn, further information about the geologic environment 100 may become available as feedback (optionally as input to the system). An operation may pertain to a reservoir that exists in the geologic environment 100 such as the reservoir 101. A technique may provide information (as an output) that specifies one or more location coordinates of a feature in a geologic environment, one or more characteristics of a feature in a geologic environment, etc.

The geologic environment 100 may be referred to as a formation or may be described as including one or more formations. A formation may be a unit of lithostratigraphy such as a body of rock that is sufficiently distinctive and continuous.

A system may be implemented to process seismic data, optionally in combination with other data. Processing of data may include generating one or more seismic attributes, rendering information to a display or displays, etc. A process or workflow may include interpretation, which may be performed by an operator that examines renderings of information (to one or more displays, etc.) and that identifies structure or other features within such renderings. Interpretation may be or include analyses of data with a goal to generate one or more models and/or predictions (about properties and/or structures of a subsurface region).

A system may include features of a framework such as the PETREL seismic to simulation software framework (Schlumberger Limited, Houston, Texas). Such a framework can receive seismic data and other data and allow for interpreting data to determine structures that can be utilized in building a simulation model.

A system may include add-ons or plug-ins that operate according to specifications of a framework environment. As an example, a framework may be implemented within or in a manner operatively coupled to the DELFI cognitive exploration and production (E&P) environment (Schlumberger, Houston, Texas), which is a secure, cognitive, cloud-based collaborative environment that integrates data and workflows with digital technologies, such as artificial intelligence and machine learning. As an example, such an environment can provide for operations that involve one or more frameworks.

Seismic data may be processed using a framework such as the OMEGA framework (Schlumberger Limited, Houston, TX). The OMEGA framework provides features that can be implemented for processing of seismic data through prestack seismic interpretation and seismic inversion.

A framework for processing data may include features for 2D line and 3D seismic surveys. Modules for processing seismic data may include features for prestack seismic interpretation (PSI), optionally pluggable into a framework such as the DELFI framework environment.

In FIG. 1, the geologic environment 100 includes an offshore portion and an on-shore portion. A geologic environment may be or include one or more of an offshore geologic environment, a seabed geologic environment, an ocean bed geologic environment, etc.

The geologic environment 100 may be outfitted with one or more of a variety of sensors, detectors, actuators, etc. Equipment 102 may include communication circuitry that receives and that transmits information with respect to one or more networks 105. Such information may include information associated with downhole equipment 104, which may be equipment to acquire information, to assist with resource recovery, etc. Other equipment 106 may be located remote from a well site and include sensing, detecting, emitting or other circuitry and/or be located on a seabed. Such equipment may include storage and communication circuitry that stores and that communicates data, instructions, etc. One or more satellites may be provided for purposes of communications, data acquisition, etc. FIG. 1 shows a satellite 110 in communication with the network 105 that may be configured for communications, noting that the satellite may additionally or alternatively include circuitry for imagery (spatial, spectral, temporal, radiometric, etc.).

FIG. 1 also shows the geologic environment 100 as optionally including equipment 107 and 108 associated with a well that includes a substantially horizontal portion that may intersect with one or more of the one or more fractures 109; consider a well in a shale formation that may include natural fractures, artificial fractures (hydraulic fractures) or a combination of natural and artificial fractures. The equipment 107 and/or 108 may include components, a system, systems, etc. for fracturing, seismic sensing, analysis of seismic data, assessment of one or more fractures, etc.

A system may be used to perform one or more workflows. A workflow may be a process that includes a number of worksteps. A workstep may operate on data to create new data, to update existing data, etc. A system may operate on one or more inputs and create one or more results based on one or more algorithms. A workflow may be a workflow implementable in the PETREL software that operates on seismic data, seismic attribute(s), etc. A workflow may be a process implementable in the DELFI environment, etc. A workflow may include one or more worksteps that access a plug-in (external executable code, etc.). A workflow may include rendering information to a display (a display device). A workflow may include receiving instructions to interact with rendered information to process information and optionally render processed information. A workflow may include transmitting information that may control, adjust, initiate, etc. one or more operations of equipment associated with a geologic environment (in the environment, above the environment, etc.).

As an example, an acquisition technique can be utilized to perform a seismic survey. A seismic survey can acquire various types of information, which can include various types of waves (e.g., P, SV, SH, etc.). A P-wave can be an elastic body wave or sound wave in which particles oscillate in the direction the wave propagates. P-waves incident on an interface (at other than normal incidence, etc.) may produce reflected and transmitted S-waves (“converted” waves). An S-wave or shear wave may be an elastic body wave in which particles oscillate perpendicular to the direction in which the wave propagates. S-waves may be generated by a seismic energy sources (other than an air gun). S-waves may be converted to P-waves. S-waves tend to travel more slowly than P-waves and do not travel through fluids that do not support shear. Recording of S-waves involves use of one or more receivers operatively coupled to earth (capable of receiving shear forces with respect to time). Interpretation of S-waves may allow for determination of rock properties such as fracture density and orientation, Poisson's ratio and rock type by crossplotting P-wave and S-wave velocities, and/or by other techniques. Parameters that may characterize anisotropy of media (seismic anisotropy) include the Thomsen parameters ε, δ and γ.

Seismic data may be acquired for a region in the form of traces. For example, a technique can utilize a source for emitting energy where portions of such energy (directly and/or reflected) may be received via one or more sensors (e.g., receivers). Energy received may be discretized by an analog-to-digital converter that operates at a sampling rate. Acquisition equipment may convert energy signals sensed by a sensor to digital samples at a rate of one sample per approximately 4 milliseconds (ms). Given a speed of sound in a medium or media, a sample rate may be converted to an approximate distance. The speed of sound in rock may be of the order of around 5 kilometer (km) per second. Thus, a sample time spacing of approximately 4 ms would correspond to a sample “depth” spacing of about 10 meters (assuming a path length from source to boundary and boundary to sensor). A trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing scenario is divided by two (to account for reflection), for a vertically aligned source and sensor, the deepest boundary depth may be estimated to be about 10 km (assuming a speed of sound of about 5 km per second).

As mentioned, seismic data may be acquired and analyzed to understand better subsurface structure of a geologic environment. Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less than 1 Hz and/or optionally more than 100 Hz). Seismic data may be processed and interpreted, for example, to understand better composition, fluid content, extent and geometry of subsurface rocks.

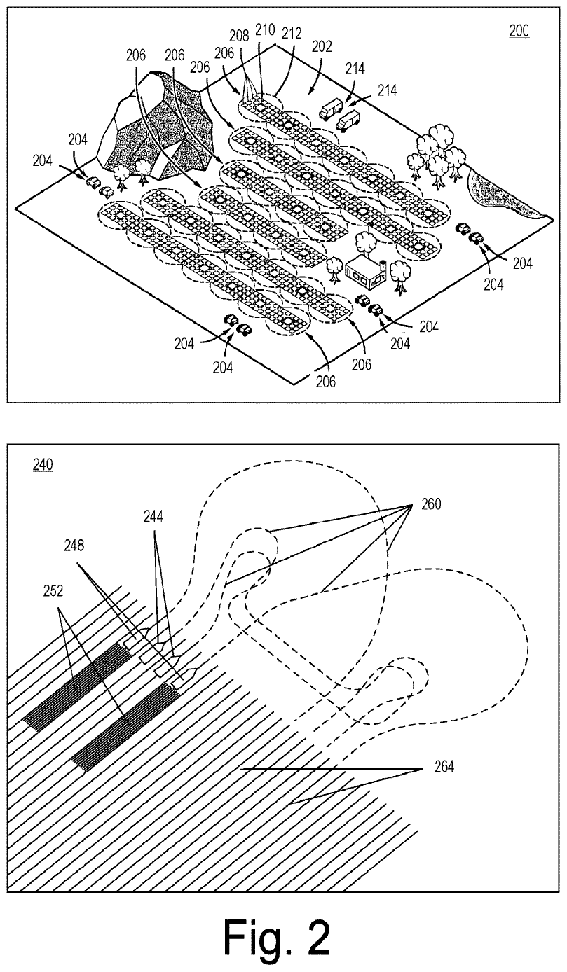

FIG. 2 shows an example of a simplified schematic view of a land seismic data acquisition system 200 and an example of a simplified schematic view of a marine seismic data acquisition system 240.

As shown with respect to the system 200, an area 202 to be surveyed may or may not have physical impediments to direct wireless communication between a recording station 214 (which may be a recording truck) and a vibrator 204. A plurality of vibrators 204 may be employed, as well as a plurality of sensor unit grids 206, each of which may have a plurality of sensor units 208.

As illustrated in FIG. 2 with respect to the system 200, approximately 24 to about 28 sensor units 208 may be placed in a vicinity (a region) around a base station 210. The number of sensor units 208 associated with each base station 210 may vary from survey to survey. Circles 212 indicate an approximate range of reception for each base station 210.

In the system 200 of FIG. 2, the plurality of sensor units 208 may be employed in acquiring and/or monitoring land-seismic sensor data for the area 202 and transmitting the data to the one or more base stations 210. Communications between the vibrators 204, the base stations 210, the recording station 214, and the seismic sensors 208 may be wireless (at least in part via air for a land-based system; or optionally at least in part via water for a sea-based system).

In the system 240 of FIG. 2, one or more source vessels 240 may be utilized with one or more streamer vessels 248 or a vessel or vessels may tow both a source or sources and a streamer or streamers 252. In the example of FIG. 2, the vessels 244 and 248 (e.g., or just the vessels 248 if they include sources) may follow predefined routes (e.g., paths) for an acquisition geometry that includes inline and crossline dimensions. As shown, routes 260 can be for maneuvering the vessels to positions 264 as part of the survey. As an example, a marine seismic survey may call for acquiring seismic data during a turn (e.g., during one or more of the routes 260).

The example systems 200 and 240 of FIG. 2 demonstrate how surveys may be performed according to an acquisition geometry that includes dimensions such as inline and crossline dimensions, which may be defined as x and y dimensions in a plane or surface where another dimension, z, is a depth dimension. As explained, time can be a proxy for depth, depending on various factors, which can include knowing how many reflections may have occurred as a single reflection may mean that depth of a reflector can be approximated using one-half of a two-way traveltime, some indication of the speed of sound in the medium and positions of the receiver and source (e.g., corresponding to the two-way traveltime).

Two-way traveltime (TWT) can be defined as the elapsed time for a seismic wave to travel from its source to a given reflector and return to a receiver (e.g., at a surface, etc.). As an example, a minimum two-way traveltime can be defined to be that of a normal-incidence wave with zero offset.

As an example, a seismic survey can include points referred to as common midpoints (CMPs). In multichannel seismic acquisition, a CMP is a point that is halfway between a source and a receiver that is shared by a plurality of source-receiver pairs. In such a survey, various angles may be utilized that may define offsets (e.g., offsets from a CMP, etc.). In a CMP approach, redundancy among source-receiver pairs can enhance quality of seismic data, for example, via stacking of the seismic data. A CMP can be vertically above a common depth point (CDP), or common reflection point (CRP). As an example, seismic data may be presented as a gather, which can be an image of seismic traces that share an acquisition parameter, such as a common midpoint gather (CMP gather or CMG), which contains traces having a common midpoint (CMP). In such an example, a CMG may be presented with respect to a horizontal dimension and a time dimension, which may be a TWT dimension.

As an example, a seismic survey can include points referred to as downward reflection points (DRPs). A DRP is a point where seismic energy is reflected downwardly. For example, where multiple interfaces exists, seismic energy can reflect upwardly from one interface, reach a shallower interface and then reflect downwardly from the shallower interface.

As an example, a seismic survey may be an amplitude variation with offset (AVO) survey. Such a survey can record variation in seismic reflection amplitude with change in distance between position of a source and position of a receiver, which may indicate differences in lithology and fluid content in rocks above and below a reflector.

AVO analysis can allow for determination of one or more characteristics of a subterranean environment (e.g., thickness, porosity, density, velocity, lithology and fluid content of rocks, etc.). As an example, gas-filled sandstone might show increasing amplitude with offset; whereas, a coal might show decreasing amplitude with offset. AVO analysis can be suitable for young, poorly consolidated rocks, such as those in the Gulf of Mexico.

As an example, a method may be applied to seismic data to understand better how structural dip may vary with respect to offset and/or angle as may be associated with emitter-detector (e.g., source-receiver) arrangements of a survey, for example, to estimate how suitable individual offset/angle gathers are for AVO imaging. As explained, a gather may be a collection of seismic traces that share an acquisition parameter, such as a common midpoint (CMP), with other collections of seismic traces. For example, consider an AVO survey that includes a plurality of emitter-detector arrangements (e.g., source-receiver pairs) with corresponding angles defined with respect to a common midpoint (CMP). Given a CMP, acquired survey data may be considered to cover a common subsurface region (e.g., a region that includes the midpoint).

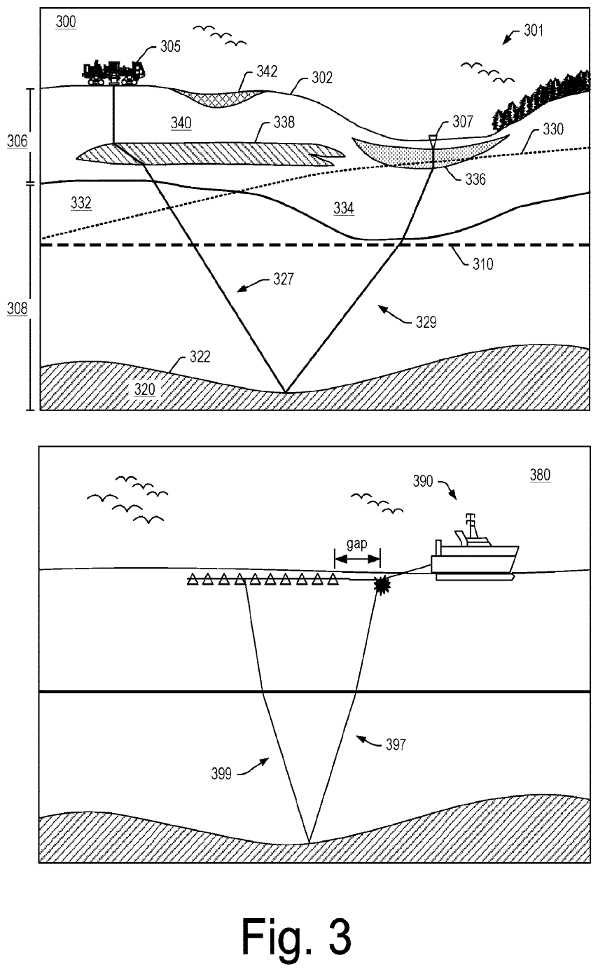

FIG. 3 shows an example of a land system 300 and an example of a marine system 380. The land system 300 is shown in a geologic environment 301 that includes a surface 302, a source 305 at the surface 302, a near-surface zone 306, a receiver 307, a bedrock zone 308 and a datum 310 where the near-surface zone 306 (e.g., near-surface region) may be defined at least in part by the datum 310, which may be a depth or layer or surface at which data above are handled differently than data below. For example, a method can include processing seismic data that aims to “place” the source 305 and the receiver 307 on a datum plane defined by the datum 310 by adjusting (e.g., “correcting”) traveltimes for propagation through the near-surface region (e.g., a shallower subsurface region).

In the example system 300 of FIG. 3, the geologic environment 301 can include various features such as, for example, a layer 320 that defines an interface 322 that can be a reflector, a water table 330, a leached zone 332, a glacial scour 334, a buried river channel 336, a region of material 338 (e.g., ice, evaporates, volcanics, etc.), a high velocity zone 340, and a region of material 342 (e.g., Eolian or peat deposits, etc.).

In FIG. 3, the land system 300 is shown with respect to downgoing rays 327 (e.g., downgoing seismic energy) and upgoing rays 329 (e.g., upgoing seismic energy). As illustrated the rays 327 and 329 pass through various types of materials and/or reflect off of various types of materials.

Various types of seismic surveys can contend with surface unevenness and/or near-surface heterogeneity. For example, a shallow subsurface can include large and abrupt vertical and horizontal variations that may be, for example, caused by differences in lithology, compaction cementation, weather, etc. Such variations can generate delays or advances in arrival times of seismic waves passing through them relative to waves that do not. By accounting for such time differences, a seismic image may be of enhanced resolution with a reduction in false structural anomalies at depth, a reduction in mis-ties between intersecting lines, a reduction in artificial events created from noise, etc.

As an example, a method can include adjusting for such time differences by applying a static, or constant, time shift to a seismic trace where, for example, applying a static aims to place a source and receiver at a constant datum plane below a near-surface zone. As an example, an amount by which a trace is adjusted can depend on one or more factors (e.g., thickness, velocity of near-surface anomalies, etc.).

In FIG. 3, the datum 310 is shown, for example, as a plane, below which strata may be of particular interest in a seismic imaging workflow. In a three-dimensional model of a geologic environment, a near surface region may be defined, for example, at least in part with respect to a datum. As an example, a velocity model may be a multidimensional model that models at least a portion of a geologic environment.

In the example of FIG. 3, the source 305 can be a seismic energy source such as a vibrator. As an example, a vibrator may be a mechanical source that delivers vibratory seismic energy to the Earth for acquisition of seismic data. As an example, a vibrator may be mounted on a vehicle (e.g., a truck, etc.). As an example, a seismic source or seismic energy source may be one or more types of devices that can generate seismic energy (e.g., an air gun, an explosive charge, a vibrator, etc.).

Vibratory seismic data can be seismic data whose energy source is a vibrator that may use a vibrating plate to generate waves of seismic energy. As an example, the frequency and the duration of emitted energy can be controllable, for example, frequency and/or duration may be varied according to one or more factors (e.g., terrain, type of seismic data desired, etc.).

As an example, a vibrator may emit a linear sweep of a duration that is of the order of seconds (e.g., at least seven seconds, etc.), for example, beginning with high frequencies and decreasing with time (downsweeping) or going from low to high frequency (upsweeping). As an example, frequency may be changed (e.g., varied) in a nonlinear manner (e.g., certain frequencies are emitted longer than others, etc.). In various vibrator scenarios, resulting source wavelet can be one that is not impulsive. As an example, parameters of a vibrator sweep can include start frequency, stop frequency, sweep rate and sweep length.

As an example, a vibrator may be employed in land acquisition surveys for areas where explosive sources may be contraindicated (e.g., via regulations, etc.). As an example, more than one vibrator can be used simultaneously (e.g., in an effort to improve data quality, etc.).

As an example, a receiver may be a may be a UNIQ sensor unit (Schlumberger Limited, Houston, Texas). As an example, a sensor unit can include a geophone, which may be configured to detect motion in a single direction. As an example, a geophone may be configured to detect motion in a vertical direction. As an example, three mutually orthogonal geophones may be used in combination to collect so-called 3C seismic data. As an example, a sensor unit that can acquire 3C seismic data may allow for determination of type of wave and its direction of propagation. As an example, a sensor assembly or sensor unit may include circuitry that can output samples at intervals of 1 ms, 2 ms, 4 ms, etc. As an example, an assembly or sensor unit can include an analog to digital converter (ADC) such as, for example, a 24-bit sigma-delta ADC (e.g., as part of a geophone or operatively coupled to one or more geophones). As an example, a sensor assembly or sensor unit can include synchronization circuitry such as, for example, GPS synchronization circuitry with an accuracy of about plus or minus 12.5 microseconds. As an example, an assembly or sensor unit can include circuitry for sensing of real-time and optionally continuous tilt, temperature, humidity, leakage, etc. As an example, an assembly or sensor unit can include calibration circuitry, which may be self-calibration circuitry.

In FIG. 3, the system 380 includes equipment 390, which can be a vessel that tows one or more sources and one or more streamers (e.g., with receivers). In the system 380, a source of the equipment 390 can emit energy at a location and a receiver of the equipment 390 can receive energy at a location. The emitted energy can be at least in part along a path of the downgoing energy 397 and the received energy can be at least in part along a path of the upgoing energy 399.

In various systems, for one or more reasons, a gap in coverage may exist. For example, in the system 380 a gap is identified and labeled where the gap may be defined as a distance between a seismic source and a seismic receiver. In such an example, the distance may be considered a practical or a safe distance for locating a seismic receiver from a seismic source. If a seismic receiver is too close to a seismic source, the seismic receiver may experience a rather large shock wave and/or may otherwise experience energy that may be quite high and raise concerns with calibration, dynamic range, etc.

In the examples of FIG. 3, the paths are illustrated as single reflection paths for sake of simplicity. In the environments illustrated, additional interactions, reflections can be expected. For example, ghosts may be present. A ghost can be defined as a short-path multiple, or a spurious reflection that occurs when seismic energy initially reverberates upward from a shallow subsurface and then is reflected downward, such as at the base of weathering or between sources and receivers and the sea surface. As an example, the equipment 390 can include a streamer that is configured to position receivers a distance below an air-water interface such that ghosts can be generated where upgoing energy impacts the air-water interface and then reflects downward to the receivers. In such an example, a process may be applied that aims to “deghost” seismic data. Deghosting can be applied to marine seismic survey data where such a process aims to attenuate signals that are downgoing from an air-water interface (i.e., sea surface interface). As mentioned, one or more other techniques, technologies, etc., may be utilized for seismic surveying (e.g., ocean bottom cables, ocean bottom nodes, etc.).

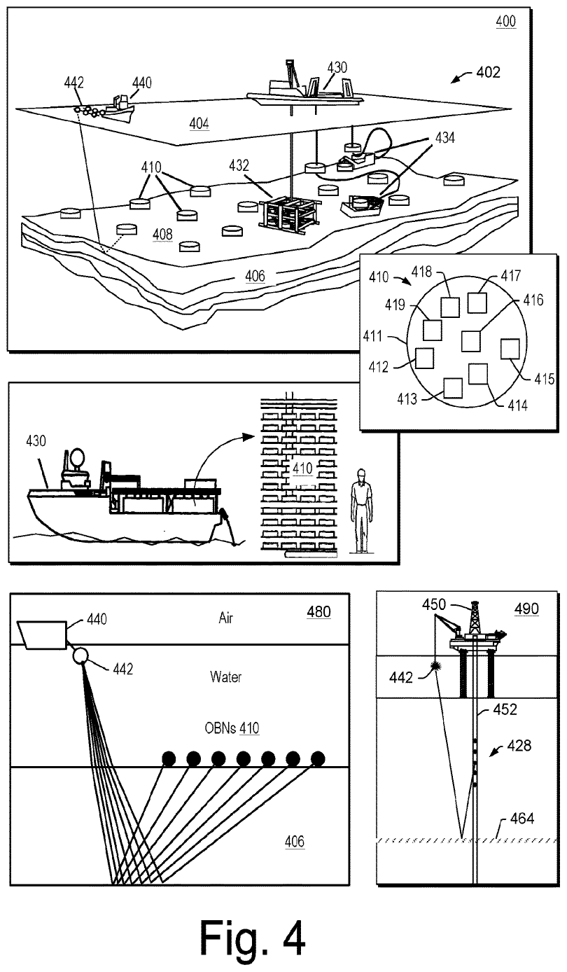

FIG. 4 shows a system 400 for acquisition of information in a geologic environment 402 that includes an air-water surface 404, a formation 406 and a seabed 408 (e.g., water-bed interface) where nodes 410 are positioned on the seabed 408. Equipment may be utilized to position the nodes 410 on the seabed 404 and retrieve the nodes 410 from the seabed 404. Such equipment may include one or more vessels 430, one or more carriers 432 and one or more vehicles 434, which may be autonomous, semi-autonomous, etc. (remotely operated vehicles (ROVs), etc.). The system 400 may include a seismic source vessel 440 that includes one or more seismic sources 442. The seismic source vessel 440 may travel a path while, at times, emitting seismic energy from the one or more sources 442. In such an approach, the nodes 410 can receive portions of the seismic energy, which can include portions that have travelled through the formation 406. Analysis of received seismic energy by the nodes 410 may reveal features of the formation 406.

In FIG. 4, the vessel 430 is shown as including nodes 410 as cargo arranged on racks. The nodes 410 can be deployed to form an array, for example, according to a survey plan. An array of nodes may be cabled or un-cabled. A cable may be relatively light weight and utilized to deploy a node receiver line with nodes coupled to the cable at spaced intervals. A rack can be utilized to securely store nodes in slots along multiple rows and columns. An individual slot may include a communications portal that can establish communication via contact(s) and/or contactless/wireless with an individual node seated in the individual slot for download of information, etc. A rack can include charger circuitry that can charge one or more batteries of an individual node seated in an individual slot. A node can be sealed such that components (circuitry, one or more batteries, etc.) are not exposed to water when the node is deployed on an underwater bed. A seal may be a hermetic seal that aims to prevent passage of air and/or water. A seal or seals can aim to prevent intrusion of water from an exterior region to an interior region of a node. Such a node can be considered to be water-tight. A sealed node can be a self-contained piece of equipment that can sense information independent of other equipment when positioned on an underwater surface that may be a seabed.

A rack may be dimensioned in accordance with shipping container dimensions such as about 3 meters by about 7 meters by about 3 meters. As shown in FIG. 4, with reference to a silhouette of a person that is about 1.8 meters in height, a node may be about a meter or less in diameter and about half a meter in height or less.

In FIG. 4, the one or more sources 442 may be an air gun or air gun array (a source array). A source can produce a pressure signal that propagates through water into a formation where acoustic and elastic waves are formed through interaction with features (structures, fluids, etc.) in the formation. Acoustic waves can be characterized by pressure changes and a particle displacement in a direction of which the acoustic wave travels. Elastic waves can be characterized by a change in local stress in material and a particle displacement. Acoustic and elastic waves may be referred to as pressure and shear waves, respectively; noting that shear waves may not propagate in water. Collectively, acoustic and elastic waves may be referred to as a seismic wavefield.

Material in a formation may be characterized by one or more physical parameters such as density, compressibility, and porosity. In the geologic environment 402 of FIG. 4, energy emitted from the one or more sources 442 can be transmitted to the formation 406; however, elastic waves that reach the seabed 408 will not propagate back into the water. Such elastic waves may be received by sensors of the nodes 410. The nodes 410 can include motion sensors that can measure one or more of displacement, velocity and acceleration. A motion sensor may be a geophone, an accelerometer, etc. As to pressure waves, the nodes 410 can include pressure wave sensors such as hydrophones.

In FIG. 4, the nodes 410 can include sensors for acquiring seismic wavefield information at the seabed 408. Each of the nodes 410 can include one or more hydrophones and/or one or more motion sensors (one or more geophones, one or more accelerometers, etc.).

A node can include various types of circuitry. Such circuitry can include circuitry that can digitize (analog to digital conversion ADC circuitry) and can include circuitry that can record signals (a microcontroller, a processor, etc., operatively coupled to memory). Each of the nodes 410 can include a housing 411, sensors 412 and 413, one or more microcontrollers or processors 414, one or more batteries 415, memory 416, ADC circuitry 417, a compass 418, communication circuitry 419, etc. As an example, a node can include one or more clocks, which may be amenable to calibration, synchronization, etc. For example, consider synchronizing to a signal, calibrating against a value, etc. As an example, a node can provide for receiving seismic energy and generating digital data that can be coded or otherwise stamped with information corresponding to time (e.g., according to one or more clocks). Various components of a node may be operatively coupled via wires, connectors, etc. A node can include one or more circuit boards (printed circuit boards, etc.) that can provide for electrical connections between various components, etc.

After deployment, one or more acoustic techniques may be utilized to determine node locations. A technique may employ acoustic pinging where acoustic pingers emit relatively high-frequency pings that are substantially above the maximum frequency of interest for seismic applications. Such relatively high-frequency acoustic signals can be picked up by one or more seismic sensors. Triangulation or one or more other techniques may be utilized to determine node locations for nodes deployed on an underwater surface such as a seabed.

Nodes may be utilized to acquire information spatially and temporally such as in a time-lapse seismic survey, which may be a four-dimensional seismic survey (4D seismic survey). A seismic image of a formation may be made for a first survey and a seismic image of the formation may be made for a second survey where the first and second surveys are separated by time (lapse in time). In such an approach, a comparison of the images can infer changes in formation properties that may be tied to production of hydrocarbons, injection of water or gas, etc.

A first survey may be referred to as a baseline survey, while a subsequent survey may be referred to as a monitor survey. To minimize artifacts in differences between seismic images from successive lapses, a monitor survey may aim to replicate a configuration of a corresponding baseline survey. Where nodes are utilized at various positions on a seabed for a baseline survey, a monitor survey may aim to place nodes on the seabed in a manner that replicates the various positions of the nodes of the baseline survey. For the monitor survey, the nodes may be the same nodes, include some of the same nodes, include some different nodes or may be different nodes. A service may have a stock of nodes that can be utilized for various surveys where once a survey is complete, the nodes are retrieved, transported and positioned for another survey. Such a service may update, replace, etc., nodes from time to time.

A position to within a few meters of accuracy of one or more nodes may be determined via one or more of GPS, an acoustic positioning system (a short-baseline (SBL) or ultra-short baseline (USBL) acoustic system), and one or more other types of systems.

A node can include sensor circuitry for acquiring measurements of a seismic pressure wavefield and its gradient; consider sensor circuitry that can measure a seismic pressure wavefield and its gradient in vertical and crossline directions.

A node can include point-receiver circuitry. A point-receiver approach can combine hydrophones with tri-axial microelectromechanical system (MEMS) accelerometers. In such an approach, the MEMS accelerometers can measure a substantial bandwidth of particle acceleration due to seismic wavefields. Measurements of particle acceleration can be directly related to a gradient in a pressure wavefield. A node may include the ISOMETRIX technology, which includes point-receiver circuitry (Schlumberger Limited, Houston, Texas).

In the example of FIG. 4, one of the nodes 410 may be connected to one or more other nodes of the nodes 410 via a cable. A vessel may include a cable that is operatively coupled to at least one node. In the system 400 of FIG. 4, nodes may be deployed according to a survey plan in a grid pattern; consider placement of nodes on a seabed according to an x,y grid where distance between adjacent nodes may be of the order of hundreds of meters. As shown in the system 400, the seismic source vessel 440 may be employed with the one or more sources 442 that can emit energy, which can, in turn, be received via one or more of the nodes 410.

As an example, a common shot approach 480 may be utilized, as illustrated via the formation 406, the OBNs 410, the seismic source vessel 440 and the one or more sources 442. As explained, the vessel 440 can tow one or more sources at or below an air-water interface where the OBNs 410 can be positioned on a water-formation interface (e.g., a seafloor, seabed, ocean bottom, sea bottom, etc.). As shown, the energy of the source or the sources 442 passes through the water and then into the formation 406 where a portion of the energy is reflected at an interface (e.g., a reflector). As shown, energy can reflect off the interface and progress upwardly to the OBNs 410, which can be receivers that record the energy.

When seismic traces of a gather come from a single shot and many receivers, they can form a common shot gather; whereas, a single receiver with many shots can form a common receiver gather. A shot gather is a plot of traces with respect to line distance (e.g., an inline or a crossline series of receivers) with respect to time. Such a plot may be referred to as an image, which includes information about a subsurface region; noting that traces may be processed to generate one or more other types of images of a subsurface region.

Also shown in FIG. 4 is an inset of a zero-offset vertical seismic profile (VSP) scenario 490. In such a scenario, an acquisition geometry may be limited to an ability to position equipment that is physically coupled to a rig 450. As shown, for given the acquisition geometry, there may be no substantial offset between the source 442 and a bore 452. In such a scenario, a zero-offset VSP may be acquired where seismic waves travel substantially vertically down to a reflector (see the layer 464) and up to receivers 428, which may be a receiver array. Where one or more vessels are employed, one or more other types of surveys may be performed. A three-dimensional VSP may be performed using a vessel. As an example, a VSP may be performed using one or more nodes, etc.

Some examples of techniques that can process seismic data include migration and migration inversion, which may be implemented for purposes such as structural determination and subsequent amplitude analysis. In seismic exploration, signal can be defined as a part of a recorded seismic record (e.g., events) that is decipherable and useful for determining subsurface information (e.g., relevant to the location and production of hydrocarbons, etc.). Migration and migration inversion are techniques that can be used to extract subsurface information from seismic reflection data.

As an example, a migration technique can include predicting a coincident source and receiver at depth at a time equal to zero; an approach that may be extended for heterogeneous media and to accommodate two-way propagation in a local sense at points from the source to a target reflector and back from the reflector to the receiver and in a global sense, separately for each of the two legs from the source to the reflector and from the reflector to the receiver. Such an approach for two-way wave propagation migration may provide for quantitative and definitive definition of the roles of primaries and multiples in migration where, for example, migration of primaries can provide subsurface structure and amplitude information.

Various techniques that can be used to predict a wavefield inside a volume from (measured) values of a field on a surface surrounding the volume involve Green's theorem. Green's theorem may be implemented, for example, as part of a process for a finite volume model prediction of the so-called “source and receiver experiment” for two-way waves at depth. As an example, Green's theorem can predict a wavefield at an arbitrary depth z between a shallower depth “a” and a deeper depth “b”.

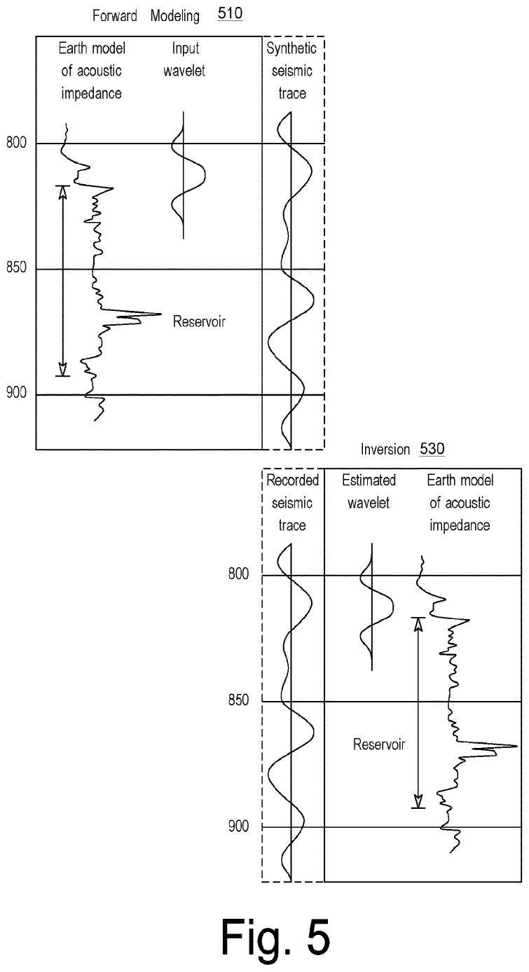

FIG. 5 shows an example of forward modeling 510 and an example of inversion 530 (e.g., an inversion or inverting). As shown, the forward modeling 510 progresses from an earth model of acoustic impedance and an input wavelet to a synthetic seismic trace while the inversion 530 progresses from a recorded seismic trace to an estimated wavelet and an Earth model of acoustic impedance. As an example, forward modeling can take a model of formation properties (e.g., acoustic impedance as may be available from well logs) and combine such information with a seismic wavelength (e.g., a pulse) to output one or more synthetic seismic traces while inversion can commence with a recorded seismic trace, account for effect(s) of an estimated wavelet (e.g., a pulse) to generate values of acoustic impedance for a series of points in time (e.g., depth).

Acoustic impedance is the opposition of a medium to a longitudinal wave motion. Acoustic impedance is a physical property whose change determines reflection coefficients at normal incidence, that is, seismic P-wave velocity multiplied by density. Acoustic impedance characterizes the relationship between the acting sound pressure and the resulting particle velocity.

During the propagation of seismic wave along a ray path, a seismic wave transmits through or reflects at a material boundary and/or converts its vibration mode between P-wave and S-wave. An observed amplitude of a seismic wave depends on an acoustic impedance contrast at a material boundary between an upper medium and a lower medium. Acoustic impedance, Z, can be defined by a multiplication of density, ρ, and seismic velocity, Vp, in each media. Acoustic impedance Z tends to be proportional to Vp for the many sedimentary and crustal rocks (e.g., granite, anorthite, pyrophyllite, and quartzite), except for some ultramafic rocks (e.g., dunite, eclogite, and peridotite) in the mantle.

In various instances, an inversion problem may be ill-posed for one or more reasons. Recorded data can include discrepancies including, for example, missing near offsets (e.g., due to gaps, etc.), and multiple events with other artifacts that contaminate the model of primaries that is inverted for. Artifacts can also be associated with inversion inaccuracies coming from inaccurate physics simulation (e.g., inversion of 3D data using 2D inversion, wavelet estimation errors, etc.).

For various reasons, a seismic survey may have coverage issues. For example, certain subsurface structures may impact “illumination” of one or more regions by seismic energy. In seismology, illumination can refer to an ability for seismic energy to fall on a reflector and thus be available to be reflected. Illumination can depend on source-receiver configuration (e.g., a survey geometry) and velocity distribution such as, for example, irregular velocity contrasts that may bend raypaths differently than adjacent raypaths. Various regions can have complicated velocity variations, for example, consider high-velocity contrast regions and subsalt regions.

A subsalt region can be an exploration and production play type in which prospects exist below salt layers. Prospecting for such regions below salt layers can pose challenges with respect to illumination, which may result in seismic data of poor quality. The Gulf of Mexico includes subsalt-producing fields; noting that subsalt regions also exist in other parts of the world such as, for example, offshore Brazil in the Santos, Campos and Espirito Santo basins.

A region below salt (e.g., a subsalt region) may be referred to as a pre-salt layer. As an example, a region may include a diachronous series of geological formations on a continental shelve of an extensional basin formed after the break-up of Gondwana, which may be characterized by deposition of thick layers of evaporites that can be composed mostly of salt. In various regions, some petroleum generated from sediments in a pre-salt layer may not have migrated upward to post-salt layers above, for example, due to one or more salt domes. Such types of regions exist off the coast of Africa and the coast of Brazil. Total pre-salt hydrocarbon reserves are estimated to be a substantial fraction of the world's hydrocarbon reserves.

Off the coast of Brazil, oil and natural gas reserves lie below an approximately 2,000 m (6,600 ft) thick layer of salt, which in turn is beneath more than 2,000 m (6,600 ft) of post-salt sediments in places, which in turn is under water depths between 2,000 m and 3,000 m (6,600 ft and 9,800 ft) in the South Atlantic. Drilling through rock and salt to extract pre-salt oil and gas can be complicated and costly. As explained, seismic surveying can be challenging in such regions, which can introduce uncertainties in planning, drilling, etc.

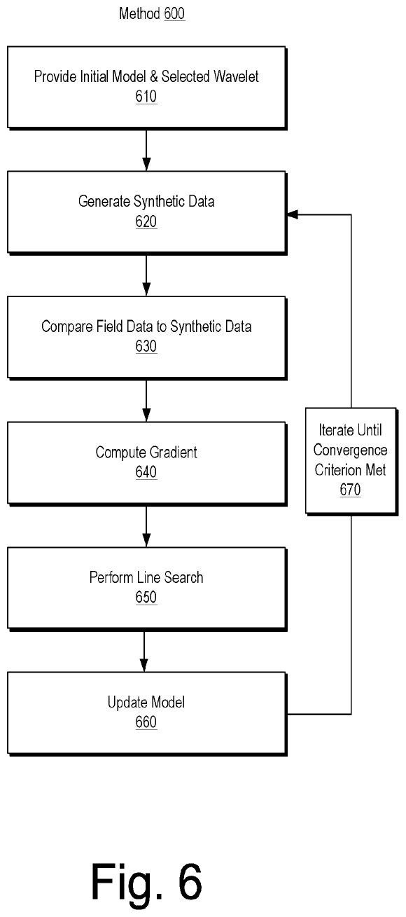

FIG. 6 shows an example of a method 600 that can perform a full waveform inversion (FWI). As shown, the method 600 includes a provision block 610 for providing an initial model and a selected wavelet, a generation block 620 for generating synthetic seismic data using the model and the wavelet, a comparison block 630 for comparing the synthetic seismic data to field seismic data, a computation block 640 for computing a gradient, a performance block 650 for performing a line search and an update block 660 for updating the model to provide an updated model, which may then be used by the generation block 620. As shown, per an iteration block 670, the method 600 can proceed in an iterative manner until one or more convergence criteria are met, which may be based on error between synthetic seismic data and field seismic data. As an example, the method 600 may be implemented by a computational framework such as, for example, the OMEGA framework.

As an example, a model can be a velocity model. A velocity model can be a single dimensional model or a multidimensional model that provides a spatial distribution of velocity in a subsurface environment. For example, consider a model that uses constant-velocity units (layers), through which raypaths obeying Snell's law can be traced. As mentioned, acoustic impedance and velocity are related and, as explained with respect to FIG. 5, a model (e.g., acoustic impedance and/or velocity) can be utilized for forward modeling and inversion (e.g., inverting).

As with various types of inversions, convergence may occur to a local solution rather than to a global solution. For example, a model may be generated that satisfies a local minimum in error where, in actuality, a model can be generated that satisfies a global minimum in error. In other words, the method 600 can get stuck in a sub-optimal solution space such that a generated model is sub-optimal.

As explained with respect to FIG. 5, forward modeling can be used to generate synthetic data and an inversion can generate a model using field data (e.g., actual, real-world data). In the method 600 of FIG. 6, forward modeling is employed to generate the synthetic seismic data, which may be performed using a numerical technique such as the finite difference method (FD method). As to comparing synthetic data to actual data, while the method 600 includes gradient computation and line search, one or more of various techniques may be utilized to update a model for a subsequent iteration.

As an example, a method can include performing a seismic migration that aims to build an image of the earth's interior from recorded field seismic data by repositioning dipping reflection events into their actual geologic positions in the subsurface. As to seismic migration, consider shot-based migration that assumes that reflectors exist when the first-arrival downward wavefield is coincident with the upgoing wavefield in time and space. A seismic data shot-based migration technique can be performed by applying the adjoint of the forward modeling operator to the seismic data, although in principle, the inverse of the forward modeling operator is required. However, the adjoint operator may not be an accurate approximation to the inverse operator, especially when seismic data are imperfect due to limited recording apertures, under-sampled acquisition geometry, complex overburden, and source wavelet bandwidth limitations. As a result, a final-migrated image may be degraded with distorted amplitudes and blurred reflectivity. To partially adjust for such distortions, an imaging problem can be formulated as a linear inverse problem, whose solution can be obtained by iteratively seeking an image generating the simulated data that best match the observed data in a least-squares sense. Such an approach can be referred to as least-squares migration (LSM). A particular technique is referred to as least-squares reverse time migration (LSRTM). In such an example, a least-squares normal equation can be iteratively solved with a conjugate-gradient algorithm.

As to gradient computation, an adjoint-state technique may be utilized that includes cross-correlating forward and adjoint wavefields and summing the contributions over the time steps. For example, calculating the gradient for one source location can include: (i) solving the forward wave equation to create a shot record (e.g., while the time varying wavefield is stored for further use, noting that techniques such as subsampling can be used to reduce the storage requirements); (ii) computing the data residual (or misfit) between the predicted and observed data; and (iii) solving the corresponding discrete adjoint model using the data residual as the source, where, within the adjoint (reverse) time loop, the technique includes cross-correlate the second time derivative of the adjoint wavefield with the forward wavefield where these cross-correlations are summed to form the gradient.

The adjoint wave equation is the adjoint (transpose) of the forward wave equation. The adjoint wave equation can be defined for a continuous case and then discretized using finite-difference method operators of the same order as for the forward equation. With the variables defined and the data residual located at receiver locations (xᵣ, yᵣ) as the adjoint source, the continuous adjoint wave equation is given by:

$$m ( x , y ) \frac{{d}^{2} v ( t , x , y )}{{dt}^{2}} - Δ v ( t , x , y ) - H ( t , x , y ) = data residual$$

The adjoint acoustic wave equation is equivalent to the forward equation with the exception of the damping term H (t, x, y)=η(x, y) dv (t, x, y)/dt, which contains a first time derivative and therefore has a change of sign in its adjoint; noting that a second derivative matrix is the same as its transpose, whereas a first derivative matrix is equal to its negative transpose and vice versa. A method can include use of the Hessian matrix (e.g., Hessian), which is a square matrix of second-order partial derivatives of a scalar-valued function, or scalar field, that can describe local curvature of a function of many variables.

As explained, various issues can exist for seismic data, which can include illumination issues, particularly for regions where velocity contrasts may be high, which may be due to subsurface formations (e.g., salt, etc.). Where one or more quality issues exist, a final model (e.g. inversion result) can be subject to inaccuracies. In various workflows, a final model can be the basis for simulation(s) and where the final model includes inaccuracies such inaccuracies can impact simulation, whether convergence of iterative simulations and/or simulation results.

As to FWI for seismic reservoir characterization, components of a computational framework can include a reservoir model component, a physics component, a forward modeling component, and an inversion engine component where such components can be interlinked. For instance, a reservoir model can drive the physics which then subsequently governs the development of forward modeling. As to forward modeling, as mentioned, the FD method may be utilized (e.g., as for wavefield extrapolation, etc.); however, the FD method can be affected by numerical dispersion as the frequency bandwidth increases, forcing use of finer-sampled grids, which subsequently increases the computational cost. Cost can become increasingly high for anisotropic and elastic wave modelling owing to the spatial variations of the velocity field. For one or more such reasons, high-resolution FWI remains challenging in reservoir characterization.

As an example, a method can include performing a full waveform inversion (FWI) using synthetic seismic data and a perturbed velocity model to generate seismic survey source and receiving illumination weights. In such an example, the method can include, during performance of a FWI, dividing a raw FWI gradient with the generated seismic survey source and receiver illumination weights, which provides for updating the relative amplitude of a model updating direction. Such an approach is flexible in that it can be applied to one or more different FWI objective functions.

As an example, a method that generates and uses illumination weights can improve robustness, performance (e.g., convergence rate), penetration depth, and quality of FWI results, especially in complex geology settings such as in a salt environment. Such a method may also be utilized to perform survey design for velocity model building with FWI.

As explained, FWI is a data-driven high-fidelity and high-resolution model building technique used in the seismic industry to build an earth model. Developed as a gradient-based optimization method, FWI can utilize a full-record of seismic data to update a velocity model to best simulate a field acquired seismic waveform. As shot-based migration can be utilized in producing a FWI gradient, to derive accurate relative amplitude behavior of the gradient, hence the velocity update, a FWI method for model building can be challenging. Ideally, a method may resort to the inverse of the Hessian matrix to weight the raw FWI gradient to produce a robust velocity update. However, the Hessian matrix tends to be large and expensive to compute for practical application. An alternative approach can aim to find a suitable approximation, such as by approximating the inverse of the diagonal Hessian.

One approach to a Hessian substitute involves weighting the raw FWI gradient by the square of the source wavefield, namely source-side illumination compensation. The source-side illumination weight approach assumes infinite receiver coverage when it is derived. However, real world seismic data acquisition can be performed with one or more of a variety of arrangements of source and receiver spread. An infinite receiver coverage assumption would lead to poor velocity recovery for the deep part of a model, especially in a complex subsurface region (e.g., consider a subsalt region).

Another approach to a Hessian substitute involves using the Born approximation, such as point-spread-functions (PSFs) to calibrate the relative amplitude response of the FWI gradient, which includes both source and receiver side illumination contributions. However, as the Born approximation solely accounts for primary reflection events, such approaches limited in applicability to reflection energy. The refraction and diving waves, which are the main ingredients for driving FWI kinematic updates, are not modelled and accounted for with the Born approximation.

As an example, a method can include applying illumination compensation to improve relative amplitude of a FWI gradient and hence the convergence of the inversion for FWI update in complex geology.

As to an illumination compensation approach, a method can include, using a current model, performing a simulation to generate synthetic seismic data utilizing both source and receiver geometries from a field acquisition; perturbing the current model by a relatively small amount (e.g., velocity by approximately 10 m/s); and, using the perturbed model as starting model and the synthetic seismic data as the “observed” data, performing one iteration of a FWI update. In such an example, the FWI update produces a new source and receiver illumination weight utilizing both source and receiver geometries of the data. As explained, once the source and receiver illumination weights are generated, these can be applied to the raw gradient during a number of FWI iterations with the actual field seismic data.

The foregoing source side and receiver side approach to illumination weights performs better than an approach that considers solely source side illumination or that considers solely reflection events. As explained, model building and hence image generation can be improved by incorporating both source and receiver acquisition geometries such that illumination contributions from both are measured properly. As explained, source and receiver illumination weights can be derived using full modeling and migration, without resorting to a Born approximation assumption. Hence, via use of source side and receiver side illumination weights, refraction and diving waves can be more properly modeled and accounted for.

As an example, a method can include performing a survey design suited to velocity model building with FWI. Such a method can, rather than focusing on relative amplitude of a migration image using reflection data, include properly measuring illumination wave path of refraction and diving wave energy.

As explained, FWI, as a data-driven minimization problem, aims to directly fit observed and simulated seismic waveform in either a time domain or a frequency domain. An inversion is performed by iteratively updating velocity fields (e.g., a velocity model) to reduce the difference between the two. However, FWI has a considerable computational cost, which depends on the convergence rate of the inversion. Due to inaccurate relative amplitude in a raw FWI gradient derived from shot-based migration, a practical FWI application can demand hundreds of iterations to derive a reasonable velocity update covering a range of depths (e.g., shallow to deep) of a model.

As explained, derivation of a relative amplitude response for the FWI gradient can ideally involve weighting a raw FWI gradient with the inverse of the Hessian matrix, the matrix of the second derivatives of the data misfit functional with respect to model parameter(s). However, the Hessian matrix is too large and prohibitive to compute in real 3D applications. As explained, alternatives to the inverse of the Hessian matrix approach for robust velocity updates and expediting FWI convergence rates involve applying a pre-conditioner as a possible approximation to the Hessian matrix (e.g., a pseudo-inverse of the Hessian).

As explained, source side illumination compensation accommodates source distribution but assumes a constant illumination contribution from the receiver side for each shot (i.e., each shot has infinite receiver coverage). While such an approach may be adequate for some fixed spread acquisitions in simple geologic environments, it may lead to poor amplitude recovery for a deep part of a model in a complex geologic environment. Further, many real-world acquisition geometries have various non-fixed source-receiver spread. Hence, an infinite receiver coverage assumption can severely limit accuracy of the computed illumination weight, particularly in complex geologic environments (e.g., consider subsalt for the Gulf of Mexico, etc.).

As explained, another alterative utilizes a Born approximation of the Hessian matrix, such as through point-spread-function (PSFs) to calibrate the raw FWI gradient to derive a better relative amplitude response. PSFs have been applied in the context of least-squares migration (LSM) to perform illumination compensation. As such approaches propose to incorporate both source and receiver wavefields to properly measure the illumination contribution from both the source and receive coverage, they can forego the infinite receiver coverage assumption and, in various instances, improve amplitude for a deeper part of a model. However, the Born-based approximation accounts solely for reflection energy, while FWI updates can be driven by refraction and diving waves, which are not accounted for by Born modeling.

For complex geologic environments, both source and receiver acquisition geometries contribute to the illumination of a subsurface region. As an example, a method can account for subsurface illumination contributions and limitations from both source and receiver sides. Further, as refraction and diving waves tend to be a driving force for FWI updates, an illumination weight that accounts for both source and receiver sides can capture illumination from diving waves. Diving waves can be waves that, due to a gradual increase in velocity with depth, dive into the subsurface and then turn back again, without a clear reflection event. A diving wave can occur when velocity, v, increases linearly with depth, z (e.g., v=v₀+kz, where k is the velocity gradient with respect to depth, z).

As explained, a method can include generating and using source side and receiver side illumination weights. Such a method can include, using a current model and the source and receiver acquisition geometry from the field, performing a synthetic shots simulation. In such an example, the synthetic shot data includes the same number of shots and receivers as acquired in the field with the actual acquisition geometry. Such a simulation can be run with a selected frequency bandwidth according to a target frequency of interest from the real data. Such synthetic data can be referred to as pseudo-observed data to be used in a subsequent operation.

As to a subsequent operation, it can involve perturbing the current model by a small amount (e.g., consider velocity perturbation by approximately 10 m/s). Such a model can be referred to as a perturbed model, yet, for purposes of a FWI iteration, it can be an initial model. A method can then include performing a single FWI iteration using the pseudo-observed data and the perturbed model, along with a suitable objective function. As the perturbed model is the current model perturbed by a relatively small amount, risk of cycle-skipping issues during this FWI run can be minimal. In such an example, FWI can be performed with a suitable objective function that can recover a uniform velocity perturbation across an entire model imprinted with illumination contribution from both the source and receiver acquisition geometries. The output from a single FWI iteration produces a targeted illumination weight volume that captures the illumination contribution from the real data acquisition geometry and the wave-path response of the complex velocity structure. In addition, it captures the illumination wave-path of the refracted and diving wave energy since a full waveform simulation is utilized rather than a Born approximation. A model perturbation method for illumination weights can also include possible illumination contributions from multiples, especially for surface related multiples if a free-surface condition is included in the modeling.

As to cycle-skipping, it can occur due to a non-convex objective function where FWI is formulated as the minimization of the objective function, which may be defined using the L2-norm of data residuals. Cycle-skipping occurs when predicted data for a corresponding event are more than half a cycle away from recorded data for the corresponding event. Cycle-skipping can lead FWI to converge to a local minimum, which, as explained, results in an incorrect estimation of model parameters. Cycle-skipping can be addressed in various manners. For example, building an initial model that is accurate enough to produce the predicted data less than half a cycle away from the recorded data. While such an approach can guarantee, at least to some extent, that the successive estimates of the model parameters are carried out within a basin of attraction of the global minimum, it is usually difficult to generate such an accurate initial model. Another approach implements a multiscale strategy for mitigating cycle-skipping. As the lower the frequency, the wider the half cycle, if an inversion starts from a lowest frequency in the recorded data and then the frequency is increased sequentially, the possibility of cycle-skipping occurring can be substantially reduced.

As an example, a workflow that involves FWI can aim to comply with a half-wavelength criterion to reduce risk of cycle-skipping (e.g., a cycle-skipping criterion). As explained, violation of such a criterion can give rise to cycle-skipping issues between predicted and acquired data that can cause an inversion to converge at a local minimum, resulting in an inaccurate model. While least-squares FWI (LsFWI) can help to mitigate some of this risk by using a highly accurate initial model, demand for a highly accurate initial model can restrict use to basins with mature velocity models (e.g., regions that have been surveyed numerous times for a number of years, etc.). In locations where an accurate initial model is not available, an adjustive FWI (AdFWI) technique can help to build a relationship between traveltime shift and model error to adjust for an erroneous background model while also mitigating cycle-skipping issues. As an example, an approach that uses source side and receiver side illumination weights may use an adjustive FWI technique.

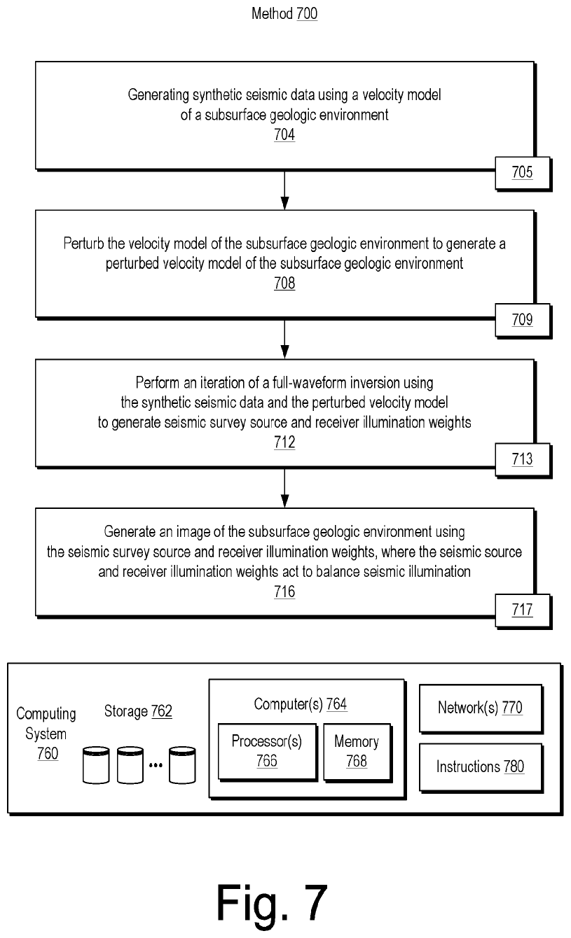

FIG. 7 shows an example of a method 700 and an example of a system 760, which may be utilized for performing at least a portion of the method 700. As shown in FIG. 7, the method 700 can include a generation block 704 for generating synthetic seismic data using a velocity model of a subsurface geologic environment, a perturbation block 708 for perturbing the velocity model of the subsurface geologic environment to generate a perturbed velocity model of the subsurface geologic environment, a performance block 712 for performing an iteration of a full-waveform inversion using the synthetic seismic data and the perturbed velocity model to generate seismic survey source and receiver illumination weights, and a generation block 716 for generating an image of the subsurface geologic environment using the seismic survey source and receiver illumination weights, where the seismic source and receiver illumination weights act to balance seismic illumination.

The method 700 is shown in FIG. 7 in association with various computer-readable media (CRM) blocks 705, 709, 713 and 717. Such blocks generally include instructions suitable for execution by one or more processors (or cores) to instruct a computing device or system to perform one or more actions. While various blocks are shown, a single medium may be configured with instructions to allow for, at least in part, performance of various actions of the method 700 (e.g., using the computing system 760, etc.). A computer-readable medium (CRM) may be a computer-readable storage medium that is not a carrier wave, that is not a signal and that is non-transitory.

FIG. 7 shows the computing system 760 as including one or more information storage devices 762, one or more computers 764, one or more network interfaces 770 and instructions 780. As to the one or more computers 764, each computer may include one or more processors (or processing cores) 766 and memory 768 for storing instructions executable by at least one of the one or more processors. A computer may include one or more network interfaces (wired or wireless), one or more graphics cards, a display interface (wired or wireless), etc. A system may include one or more display devices (optionally as part of a computing device, etc.). Memory can be a computer-readable storage medium. A computer-readable storage medium is not a carrier wave, is not a signal and is non-transitory.

As an example, a method such as the method 700 of FIG. 7 can provide for quantitatively measuring complex subsalt illumination variations in a deep part of a model of a subsurface region of interest. As explained, a model can be generated along with synthetic seismic data where the model can then be perturbed. As an example, a model may be perturbed in a uniform manner, for example, by adjusting spatial velocities by an amount that may be less than 1 percent or, for example, less than 0.5 percent of an average velocity in a selected region or regions. The amount of adjustment can depend on a cycle-skipping criterion. For example, an adjustment can be limited such that a half-cycle is not exceeded as a cycle-skipping criterion. By perturbing the model and using the synthetic seismic data as observed data, the result of a single iteration of a FWI can provide for indications of unbalance due at least in part to illumination (e.g., source side and receiver side).

As explained, a FWI can involve use of an objective function along with an optimization or minimization process. Where unbalance exists, the FWI may iterate to resolve larger errors first, which can correspond to seismic data from a well illuminated region or regions, thereby leaving a poorly illuminated region or regions somewhat unresolved as computed errors can be much smaller (e.g., weaker signal strength, weaker seismic amplitudes, etc.). A method that generates source side and receiver side illumination weights can compensate seismic data in a manner that makes it more balanced such that a FWI can better resolve one or more regions that may be poorly illuminated. By balancing regions, computed errors can be more balanced across the regions, which can help a FWI arrive at a global solution rather than at a local solution where the global solution has improved resolution in a deeper region that may have been poorly illuminated due to one or more subsurface features (e.g., salt layers, etc.). Such an approach can reduce number of iterations, increase chances of convergence and increase chance of convergence to a global solution rather than a local solution. As to perturbations, they can be made to one or more types of models that can be used in a FWI. For example, perturbations may be made in one or more velocities, one or more anisotropy fields, etc.

As explained, a method can perform FWI with source and receiver illumination compensation. For example, consider a multiscale implementation of FWI that iteratively updates model fields m to reduce misfit between observed data d and forward simulated data F(m), which can be formulated as:

$${min}_{m} J ( m ) = [ F ( m ) , d ] , \qquad ( 1 )$$

where [symbol] is a functional measuring the misfit between the simulation data (synthetic seismic data) and the observed data.

For the case of a least-squares based objective function, [symbol] can be defined as:

$${ls}_{} [ F ( m ) , d ] = \frac{1}{2} {‖ F ( m ) - d ‖}_{2}^{2} , \qquad ( 2 )$$

where

$${‖ \cdot ‖}_{2}^{2}$$

stands for the squared L2 norm.

For the case of a travel time based objective function, [symbol] can be defined as

$$[ F ( m ) , d ] = \frac{1}{2} c {‖ Δτ ‖}_{2}^{2} , \qquad ( 3 )$$

where Δτ is the measured time shift between observed data and simulated data through a 1D temporal windowed cross-correlation for every sample along time axis and where c is a quality factor such as a weight for the time shift measurement, which may be derived from cross-correlation coefficient.

As an example, a temporal window size can be selected according to a dominant frequency of an inversion frequency band.

The FWI objective function can be minimized by iteratively updating the model parameter(s) with a line-search method:

$${m}_{k + 1} = {m}_{k} + {α}_{k} {g}_{k} , \qquad ( 4 )$$

where αₓ is the step size of the k-th iteration resolved from line search, and gₖ is the model updating direction at the k-th iteration, which, in this example, is a descent direction based on the gradient computed to minimize the misfit function shown in equation (2).

As an example, an inversion can be performed both iteratively from low to high frequencies and for each individual frequency band.

As an example, a method can include generating source and receiver illumination weights and applying the weights during FWI by dividing the raw FWI gradient with the source and receiver illumination weights, which will update the relative amplitude of the model updating direction gₖ. As explained, such an approach can be flexibly applied to various different FWI objective functions.

An FWI update is much more balanced from a shallow part to a deep part of the model rather than being shallow depth dominant in seismic images generated using illumination compensation according to techniques described herein. As explained, without balancing through use of illumination weights, a well illuminated shallow part can dominate FWI iterations such that less well illuminated part(s) are not properly resolved in a resulting seismic image. As explained, seismic imaging can depend on a model such as a velocity model. Where a model is not balanced, a resulting seismic image may lack balance and hence have one or more parts that are quite well resolved while one or more other parts are less resolved. In a subsalt region where a target can be below salt (subsalt), an approach that uses illumination compensation can result in improved resolution of the target. Further, as mentioned, balancing can speed up the convergence rate of FWI inversion iterations due to improved data sensitivity to a weak illumination area or areas, which may otherwise demand hundreds of iterations to resolve (e.g., noting that more iterations also means more digital computation errors).

As an example, a method can include designing a survey using a technique that accounts for source side and receiver side Illumination where the designed survey is suitable for use in a workflow that implements FWI. In general, survey design looks to reflection rather than refraction and diving waves. A general approach to arrive at a survey geometry that delivers adequate illumination for a target reservoir can demand extensive synthetic modeling and imaging studies before actual field acquisition commences. Such a general approach tends to concentrate on checking relative amplitude of a migration image at a target reservoir as a quality assurance for different survey geometries. As mentioned, a general approach may not readily extend to FWI where information for a surveyed target region is mainly driven by refraction and diving wave energy instead of reflection energy.

A method can improve survey design for FWI workflows by providing an optimized survey geometry that best helps FWI for velocity model building. As explained, without a reliable velocity model, an accurate image through migration is unlikely. As an example, a method can consider source and receiver illumination in guiding survey design for velocity model building for a FWI workflow.

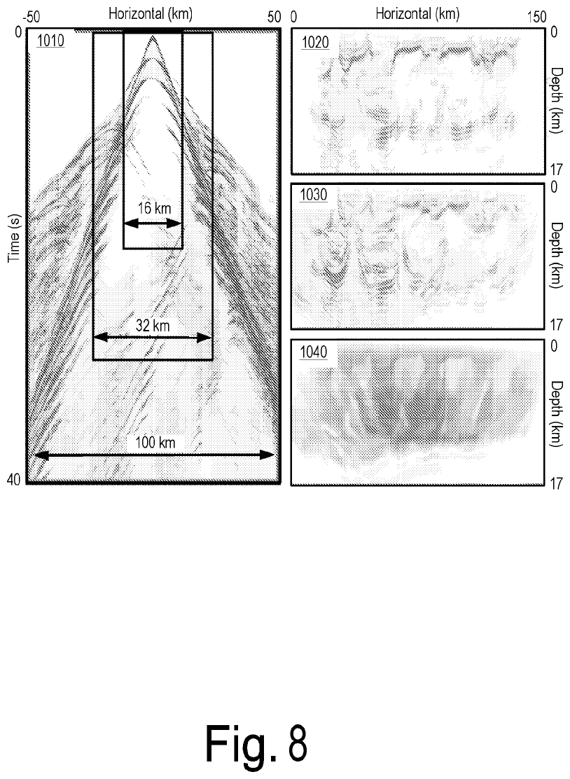

FIG. 8 shows images 1010, 1020, 1030 and 1040 of an example of source and receiver illumination computed with three different acquisition geometries using a source side and receiver side illumination approach to survey design. Specifically, FIG. 8 shows source and receiver illumination with different acquisition offset lengths at a 2 Hz frequency where the image 1010 includes the shot record for a 50 km max offset (e.g., 100 km span) and 40 seconds recording length a prospective OBN recording, for a prospective dual coil recording (16 km offset and 32 km span) and for a prospective WAZ recording (8 km offset and 16 km span). In FIG. 8, the image 1020 shows the illumination weights for the WAZ geometry with full record, the image 1030 shows the illumination weights for the dual coil geometry with full record and the image 1040 shows the illumination weights for the OBN geometry with full record.

In FIG. 8, the image 1010 is in a distance and time domain where horizontal distances are labeled for geometries with a horizontal spacing of 16 km, 32 km and 100 km and where time is from 0 seconds to 40 seconds. The images 1020, 1030 and 1040 correspond to reconstructed illumination weights as a type of depth image (e.g., depth slices) for a horizontal span of 150 km and a depth of 17 km. A comparison of the images 1020, 1030 and 1040 shows that the image 1040 is superior in terms of illumination where OBNs can be utilized for acquisition with a 50 km offset (e.g., 100 km span) that provides adequate illumination coverage for FWI to recover a proper velocity update for a deep part of a model as the true velocity perturbation being targeted to recover is set to 10 m/s uniform from shallow to deep depths. In the cases of acquisitions with 8 km offset (e.g., 16 km span) and with 16 km offset (e.g., 32 km span), while they are proven to provide an adequate migration image, lack of diving wave energy handicaps the opportunity for velocity model building using FWI. As shown in the example of FIG. 8, a number of offsets can be tested and, for example, viewed in a spatial and temporal domain, where results can be viewed in a spatial domain to determine a proper offset for use in a FWI workflow. Such an approach can be implemented as part of a survey design phase of an exploration project, which can improve processing of seismic data once acquired.

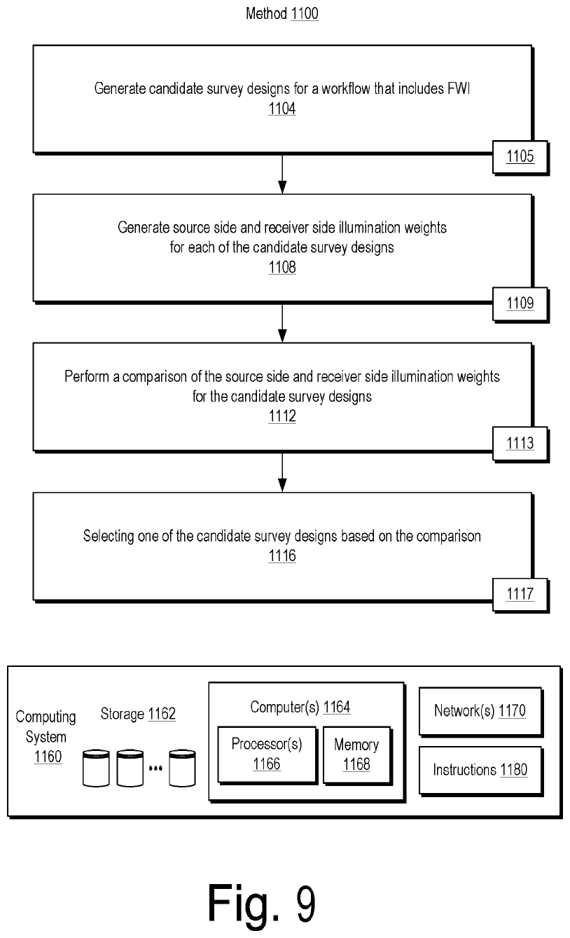

FIG. 9 shows an example of a method 1100 and an example of a system 1160, which may be utilized for performing at least a portion of the method 1100. As shown in FIG. 9, the method 100 can include a generation block 1104 for generating candidate survey designs for a workflow that includes FWI, a generation block 1108 for generating source side and receiver side illumination weights for each of the candidate survey designs, a performance block 1112 for performing a comparison of the source side and receiver side illumination weights for the candidate survey designs, and a selection block 1116 for selecting one of the candidate survey designs based on the comparison.

The method 1100 is shown in FIG. 9 in association with various computer-readable media (CRM) blocks 1105, 1109, 1113 and 1117. Such blocks generally include instructions suitable for execution by one or more processors (or cores) to instruct a computing device or system to perform one or more actions. While various blocks are shown, a single medium may be configured with instructions to allow for, at least in part, performance of various actions of the method 1100 (e.g., using the computing system 1160, etc.). A computer-readable medium (CRM) may be a computer-readable storage medium that is not a carrier wave, that is not a signal and that is non-transitory.

FIG. 9 shows the computing system 1160 as including one or more information storage devices 1162, one or more computers 1164, one or more network interfaces 1170 and instructions 1180. As to the one or more computers 1164, each computer may include one or more processors (or processing cores) 1166 and memory 1168 for storing instructions executable by at least one of the one or more processors. A computer may include one or more network interfaces (wired or wireless), one or more graphics cards, a display interface (wired or wireless), etc. A system may include one or more display devices (optionally as part of a computing device, etc.). Memory can be a computer-readable storage medium. A computer-readable storage medium is not a carrier wave, is not a signal and is non-transitory.

As explained, a model can be perturbed for various different acquisition geometries for one or more sources and receivers where the model represents a particular geologic environment, which can include a target, which, as explained, may be a subsalt target. As an example, a method can revise an acquisition geometry to account for cost, available resources, etc., along with an ability to adequately illuminate a target where a workflow includes FWI (e.g., for arriving at a model that can handle refraction and diving waves). As an example, an offset can be an acquisition geometry parameter. As an example, a method can include adjusting source and receiver spread, optionally in an iterative manner, to arrive at an acceptable illumination of a target area.

Referring again to the example of FIG. 8, the OBN survey with an offset of 50 km (100 km span) is the acquisition geometry that proves capable of adequately resolving a subsalt target region in a workflow that utilizes FWI. Such a result can improve seismic surveying of a geologic environment where a target region or target regions of interest may be at risk of poor illumination for one or more reasons. While salt has been given as an example, in various instances, surface or ocean bottom features may impact an ability to arrange sources and/or receivers. For example, consider an ocean bottom trench, an ocean bottom ridge, etc., which may complicate placement of one or more OBNs. Where a workflow includes FWI, planning of a seismic survey can employ generation of source side and receiver side illuminations weights by implementing a single FWI iteration for each candidate acquisition geometry for the seismic survey such that a comparison may be made to select one of the candidates for actual seismic data acquisition (e.g., or as a base plan that may be modified for one or more reasons). Such an approach can provide assurance that FWI can be implemented to generate a suitable model that adequately accounts for illumination of a target or targets.

As an example, a model may be utilized for survey design that accounts for a prospective acquisition geometry and another model may be utilized for FWI of acquired data that accounts for an actual acquisition geometry (e.g., consider modification of an initial model once OBNs are positioned, etc.).

As explained, various methods can be implemented to compute source and receiver illumination for refraction and diving wave energy. As explained, a FWI workflow can incorporate source and receiver illumination compensation to balance a FWI gradient for a weak illumination area, which can speed up convergence (e.g., reduce number of iterations). As explained, an approach to illumination compensation can be flexible in that it can be applied to FWI with one or more types of objective functions. As explained, a method can provide for survey design where a survey can be designed particularly for velocity model building with FWI using source and receiver illumination.

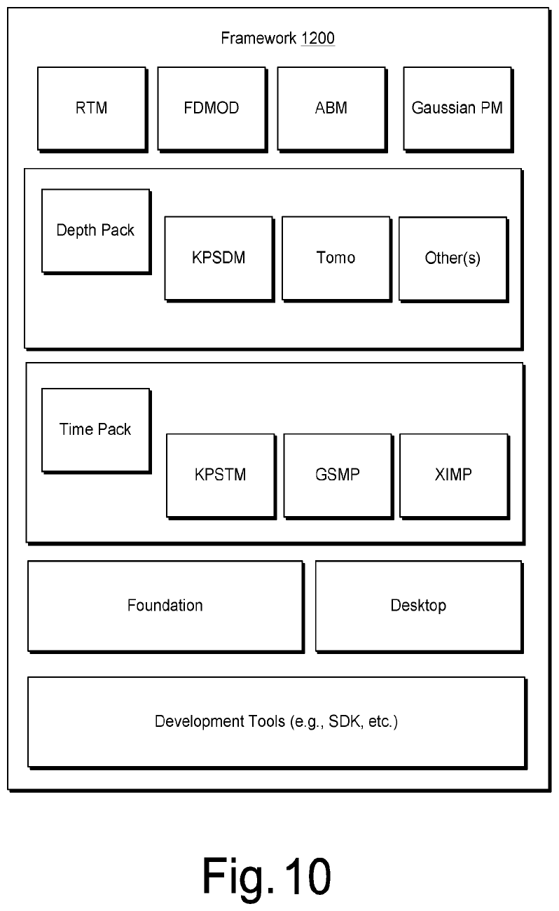

FIG. 10 shows an example of a computational framework 1200 that can include one or more processors and memory, as well as, for example, one or more interfaces. The blocks of the computational framework 1200 may be provided as instructions such as the instructions 780 of the system 760 of FIG. 7, the instructions 1180 of the system 1160 of FIG. 9, etc. The computational framework of FIG. 10 can include one or more features of the OMEGA framework, which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density.

As shown in FIG. 10, the computational framework 1200 includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools.

The framework 1200 can include features for geophysics data processing. The framework 1200 can allow for processing various types of data such as, for example, one or more of: land, marine, and transition zone data; time and depth data; 2D, 3D, and 4D surveys; isotropic and anisotropic (TTI and VTI) velocity fields; and multicomponent data.

The framework 1200 can allow for transforming seismic, electromagnetic, microseismic, and/or vertical seismic profile (VSP) data into actionable information, for example, to perform one or more actions in the field for purposes of resource production, etc. The framework 1200 can extend workflows into reservoir characterization and earth modelling. For example, the framework 1200 can extend geophysics data processing into reservoir modelling by integrating with the PETREL framework via the Earth Model Building (EMB) tools, which enable a variety of depth imaging workflows, including model building, editing and updating, depth-tomography QC, residual moveout analysis, and volumetric common-image-point (CIP) pick QC. Such functionalities, in conjunction with depth tomography and migration algorithms of the framework 1200 can produce accurate and precise images of the subsurface. The framework 1200 may provide support for field to final imaging, to prestack seismic interpretation and quantitative interpretation, from exploration to development.

As an example, the FDMOD component can be instantiated via one or more CPUs and/or one or more GPUs for one or more purposes. For example, consider utilizing the FDMOD for generating synthetic shot gathers by using full 3D, two-way wavefield extrapolation modelling, the same wavefield extrapolation logic matches that are used by RTM. FDMOD can model various aspects and effects of wave propagation. The output from FDMOD can be or include synthetic shot gathers including direct arrivals, primaries, surface multiples, and interbed multiples. The model can be specified on a dense 3D grid as velocity and optionally as anisotropy, dip, and variable density. As an example, survey designs can be modelled to ensure quality of a seismic survey, which may account for structural complexity of the model. Such an approach can enable evaluation of how well a target zone will be illuminated. Such an approach may be part of a quality control process (e.g., task) as part of a seismic workflow. As an example, a FDMOD approach may be specified as to size, which may be model size (e.g., a grid cell model size). Such a parameter can be utilized in determining resources to be allocated to perform a FDMOD related processing task. For example, a relationship between model size and CPUs, GPUS, etc., may be established for purposes of generating results in a desired amount of time, which may be part of a plan (e.g., a schedule) for a seismic interpretation workflow.

As an example, as survey data become available, interpretation tasks may be performed for building, adjusting, etc., one or more models of a geologic environment. For example, consider a vessel that transmits a portion of acquired data while at sea and that transmits a portion of acquired data while in port, which may include physically offloading one or more storage devices and transporting such one or more storage devices to an onshore site that includes equipment operatively coupled to one or more networks (e.g., cable, etc.). As data are available, options exist for tasks to be performed.

As an example, the framework 1200 can include one or more sets of instructions executable to perform one or more methods such as, for example, one or more of the methods 700, 1100, etc.

As an example, a method can include generating synthetic seismic data using a velocity model of a subsurface geologic environment; perturbing the velocity model of the subsurface geologic environment to generate a perturbed velocity model of the subsurface geologic environment; performing an iteration of a full-waveform inversion using the synthetic seismic data and the perturbed velocity model to generate seismic survey source and receiver illumination weights; and generating an image of the subsurface geologic environment using the seismic survey source and receiver illumination weights, where the seismic source and receiver illumination weights act to balance seismic illumination. In such an example, the velocity model can account for seismic survey source and receiver geometries. As an example, such a method can include, based on the image, performing a seismic survey using a plan based on the seismic survey source and receiver geometries.

As an example, a velocity model can account for salt in a subsurface geologic environment. As an example, seismic source and receiver illumination weights can be generated that act to balance seismic illumination in at least a salt region and a subsalt region of a subsurface geologic environment. In such an example, seismic surveying and/or seismic imaging can be improved, which can, for example, improve planning, drilling, etc., in such a region.

As an example, a method can include generating an image at least in part by performing a full-waveform inversion using seismic data acquired using a seismic survey with seismic survey source and receiver geometries. As explained, a method can include generation of and utilization of illumination weights that can act to balance illumination, particularly in regions that may pose challenges (e.g., pre-salt regions, etc.).

As an example, a method can include, based on an image, adjusting seismic survey source and receiver geometries to generated adjusted seismic survey source and receiver geometries. In such an example, the adjusted seismic survey source and receiver geometries can be utilized to improve seismic illumination of a region of the subsurface geologic environment. For example, consider a region that includes a subsalt region of the subsurface geologic environment.

As an example, a method can include characterizing a subsurface geologic environment based on an image. In such an example, characterizing can include identification of one or more subsurface features, which may include salt features, subsalt features, hydrocarbons, presence of a reservoir, extent of a reservoir, etc. In such an example, estimation of hydrocarbons and/or producible hydrocarbons may be improved, along with, for example, planning, drilling, etc. As an example, a method can include locating hydrocarbons in a subsurface geologic environment based on an image.

As an example, a method can include perturbing a velocity model by adjusting velocities of the velocity model. As an example, consider adjusting velocities by less than +/−100 m/s and/or adjusting velocities by less than +/−10 percent. As an example, velocities may be adjusted without violation of a cycle-skipping criterion. As an example, a method can include perturbing a velocity model by adjusting velocities by a uniform amount.

As an example, a method can include performing a full-waveform inversion in a manner that includes computing a gradient. As an example, a method can include generating an image at least in part by performing a full-waveform inversion using seismic data acquired using a seismic survey where the full-waveform inversion includes computing a gradient and dividing the gradient by seismic survey source and receiver illumination weights.

As an example, a system can include a processor; memory operatively coupled to the processor; and processor-executable instructions stored in the memory to instruct the system to: generate synthetic seismic data using a velocity model of a subsurface geologic environment; perturb the velocity model of the subsurface geologic environment to generate a perturbed velocity model of the subsurface geologic environment; perform an iteration of a full-waveform inversion using the synthetic seismic data and the perturbed velocity model to generate seismic survey source and receiver illumination weights; and generate an image of the subsurface geologic environment using the seismic survey source and receiver illumination weights, where the seismic source and receiver illumination weights act to balance seismic illumination.

As an example, one or more computer-readable storage media can include computer-executable instructions executable to instruct a computing system to: generate synthetic seismic data using a velocity model of a subsurface geologic environment; perturb the velocity model of the subsurface geologic environment to generate a perturbed velocity model of the subsurface geologic environment; perform an iteration of a full-waveform inversion using the synthetic seismic data and the perturbed velocity model to generate seismic survey source and receiver illumination weights; and generate an image of the subsurface geologic environment using the seismic survey source and receiver illumination weights, where the seismic source and receiver illumination weights act to balance seismic illumination.

As an example, a computer program product can include computer-executable instructions to instruct a computing system to perform a method, for example, consider a method such as the method 700 of FIG. 7, the method 1100 of FIG. 9, etc.

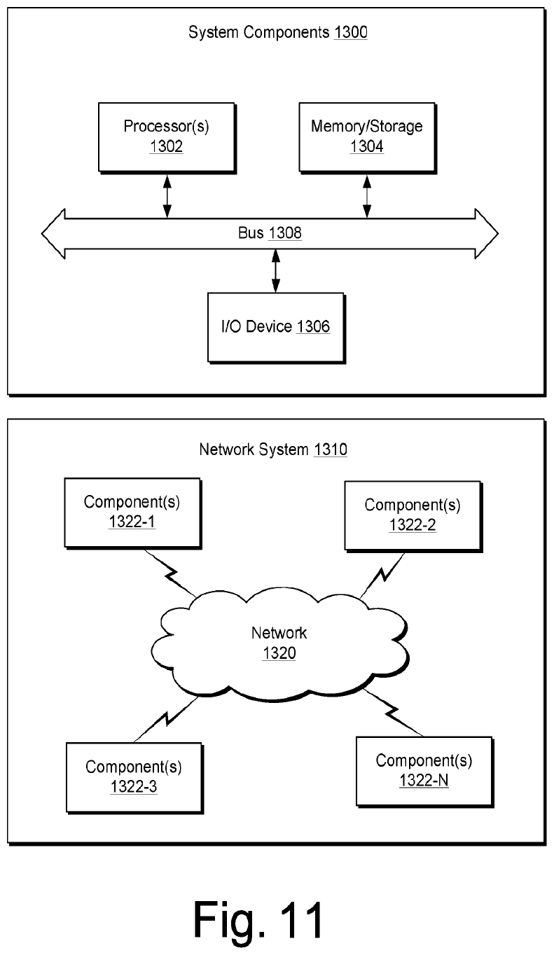

FIG. 11 shows components of a computing system 1300 and a networked system 1310 that includes a network 1320. The system 1300 includes one or more processors 1302, memory and/or storage components 1304, one or more input and/or output devices 1306 and a bus 1308. Instructions may be stored in one or more computer-readable media (memory/storage components 1304). Such instructions may be read by one or more processors (see the processor(s) 1302) via a communication bus (see the bus 1308), which may be wired or wireless. The one or more processors may execute such instructions to implement (wholly or in part) one or more attributes (as part of a method). A user may view output from and interact with a process via an I/O device (see the device 1306). A computer-readable medium may be a storage component such as a physical memory storage device such as a chip, a chip on a package, a memory card, etc. (a computer-readable storage medium).

Components may be distributed, such as in the network system 1310. The network system 1310 includes components 1322-1, 1322-2, 1322-3, . . . 1322-N. The components 1322-1 may include the processor(s) 1302 while the component(s) 1322-3 may include memory accessible by the processor(s) 1302. Further, the component(s) 1322-2 may include an I/O device for display and optionally interaction with a method. The network may be or include the Internet, an intranet, a cellular network, a satellite network, etc.

A device may be a mobile device that includes one or more network interfaces for communication of information. A mobile device may include a wireless network interface (operable via IEEE 802.11, ETSI GSM, BLUETOOTH®, satellite, etc.). A mobile device may include components such as a main processor, memory, a display, display graphics circuitry (optionally including touch and gesture circuitry), a SIM slot, audio/video circuitry, motion processing circuitry (accelerometer, gyroscope), wireless LAN circuitry, smart card circuitry, transmitter circuitry, GPS circuitry, and a battery. A mobile device may be configured as a cell phone, a tablet, etc. A method may be implemented (wholly or in part) using a mobile device. A system may include one or more mobile devices.

A system may be a distributed environment such as a so-called “cloud” environment where various devices, components, etc. interact for purposes of data storage, communications, computing, etc. A device or a system may include one or more components for communication of information via one or more of the Internet (where communication occurs via one or more Internet protocols), a cellular network, a satellite network, etc. A method may be implemented in a distributed environment (wholly or in part as a cloud-based service).

Information may be input from a display (consider a touchscreen), output to a display or both. Information may be output to a projector, a laser device, a printer, etc, such that the information may be viewed. Information may be output stereographically or holographically. As to a printer, consider a 2D or a 3D printer. A 3D printer may include one or more substances that can be output to construct a 3D object. Data may be provided to a 3D printer to construct a 3D representation of a subterranean formation. Layers may be constructed in 3D (horizons, etc.), geobodies constructed in 3D, etc. Holes, fractures, etc., may be constructed in 3D (as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
generating synthetic seismic data using a velocity model of a subsurface geologic environment;
perturbing the velocity model of the subsurface geologic environment to generate a perturbed velocity model of the subsurface geologic environment;
performing an iteration of a full-waveform inversion using the synthetic seismic data and the perturbed velocity model to generate seismic survey source and receiver illumination weights; and
generating an image of the subsurface geologic environment using the seismic survey source and receiver illumination weights, wherein the seismic source and receiver illumination weights act to balance seismic illumination.

2. The method of claim 1, wherein the velocity model accounts for seismic survey source and receiver geometries.

3. The method of claim 2, comprising, based on the image, performing a seismic survey using a plan based on the seismic survey source and receiver geometries.

4. The method of claim 1, wherein the velocity model accounts for salt in the subsurface geologic environment.

5. The method of claim 1, wherein the seismic source and receiver illumination weights act to balance seismic illumination in at least a salt region and a subsalt region of the subsurface geologic environment.

6. The method of claim 1, wherein generating the image comprises performing a full-waveform inversion using seismic data acquired using a seismic survey with seismic survey source and receiver geometries.

7. The method of claim 1, comprising, based on the image, adjusting seismic survey source and receiver geometries to generated adjusted seismic survey source and receiver geometries.

8. The method of claim 7, wherein the adjusted seismic survey source and receiver geometries improve seismic illumination of a region of the subsurface geologic environment.

9. The method of claim 8, wherein the region comprises a subsalt region of the subsurface geologic environment.

10. The method of claim 1, comprising characterizing the subsurface geologic environment based on the image.

11. The method of claim 1, comprising locating hydrocarbons in the subsurface geologic environment based on the image.

12. The method of claim 1, wherein perturbing the velocity model comprises adjusting velocities.

13. The method of claim 12, wherein the velocities are adjusted by less than +/−100 m/s.

14. The method of claim 12, wherein the velocities are adjusted by less than +/−10 percent.

15. The method of claim 12, wherein the velocities are adjusted without violation of a cycle-skipping criterion.

16. The method of claim 1, wherein perturbing the velocity model comprises adjusting velocities by a uniform amount.

17. The method of claim 1, wherein the full-waveform inversion comprises computing a gradient.

18. The method of claim 1, wherein generating the image comprises performing a full-waveform inversion using seismic data acquired using a seismic survey wherein the full-waveform inversion comprises computing a gradient and dividing the gradient by the seismic survey source and receiver illumination weights.

19. A system comprising:
a processor;
memory operatively coupled to the processor; and
processor-executable instructions stored in the memory to instruct the system to:
generate synthetic seismic data using a velocity model of a subsurface geologic environment;
perturb the velocity model of the subsurface geologic environment to generate a perturbed velocity model of the subsurface geologic environment;
perform an iteration of a full-waveform inversion using the synthetic seismic data and the perturbed velocity model to generate seismic survey source and receiver illumination weights; and
generate an image of the subsurface geologic environment using the seismic survey source and receiver illumination weights, wherein the seismic source and receiver illumination weights act to balance seismic illumination.

20. One or more computer-readable storage media comprising computer-executable instructions executable to instruct a computing system to:
generate synthetic seismic data using a velocity model of a subsurface geologic environment;
perturb the velocity model of the subsurface geologic environment to generate a perturbed velocity model of the subsurface geologic environment;
perform an iteration of a full-waveform inversion using the synthetic seismic data and the perturbed velocity model to generate seismic survey source and receiver illumination weights; and
generate an image of the subsurface geologic environment using the seismic survey source and receiver illumination weights, wherein the seismic source and receiver illumination weights act to balance seismic illumination.
